(19) United States
(12) Patent Application Publication
(10) Pub. No.: US 2008/0144642 A1
(43) Pub. Date: Jun. 19, 2008

(54) Residential gateway for ethernet based metro networks and a global hierarchical ethernet addressing system

(76) Inventor: Shaowen Song, Waterloo (CA)

Correspondence Address: Shaowen Song;Department of Physics and Computer Science, Wilfrid Laurier University, Waterloo, ON, N2L 3C5, omitted

(21) Appl. No.: 11/707,968

(22) Filed: Feb. 20, 2007

Related U.S. Application Data
(60) Provisional application No. 60/875,565, filed on Dec. 19, 2006.

(51) Int. Cl. H04L 12/28; H04B 1/66; H04J 3/16

(52) U.S. Cl. 370/401; 370/466; 375/240.01

(57) ABSTRACT

A residential gateway (RG) for distributing multimedia services to residential and business premises is disclosed. The RG connects multiple communication devices, such as TVs, telephones, computers, security cameras, and utility billing devices, to an Ethernet based metro/access network through either an optic fiber or a coaxial cable. The RG multiplexes upstream data from various communication devices into Ethernet frames according to the said Fixed-bandwidth Multimedia to Ethernet (FibME) protocol, and transmit the Ethernet frames through the link between the RG and the metro network. The RG also distributes the downstream data from the metro network to their corresponding destination devices in real time, also according to the said FibME protocol. The default bandwidth between the residential premise and the metro network is 100 Mbps full duplex. One Gbps or ten Gbps can be implemented based on the same FibME protocol for business applications. A Global Ethernet Addressing System (Global-HEAS) which will simplify the switch for the Ethernet systems is also disclosed.

This application is a continuation-in-part of U.S. Provisional Application No. 60/875,565, filed Dec. 19, 2007.

### FIELD OF THE INVENTION

The present invention relates to the field of communication networks, in particular, broadband integrated communication services to homes via Ethernet based metro networks which are realized through either optic fiber to the home (FTTH) or hybrid fiber and coaxial (HFC) infrastructure. This invention is also related to Ethernet addressing.

### BACKGROUND OF THE INVENTION

### Broadband Integrated Service to Home

The concept of integrated multiservices to home has existed for a long time. An overriding belief existed even in the early 1970's that optic fiber would one day make its way into the subscriber loop and be used to connect individual homes to the access networks, as it has been summarized by D. B. Keck, et al in their paper entitled “Passive Components in the Subscriber Loop,” published in the Journal of Lightwave Technology, Vol. 7, No. 11. November 1989. However, the road of fiber to the home (FTTH) turned out to be much longer than it was originally anticipated. Today cupper pairs for the subscriber loop have continued to exist and continue to be laid for new constructions.

Several technologies were once considered as the enabling candidate technologies for FTTH, such as the Integrated Services Digital Networks (ISDN), the Broad ISDN (B-ISDN), the Asynchronous Transfer Mode (ATM), and the Digital Subscriber Lines (DSL) and Asymmetrical DSL (ADSL). These technologies failed to make to the marketplace for different reasons.

In the ISDN case, it was the capacity of the system that cannot meet the requirements of the service demands that limited its chances for being deployed. While in the case of B-ISDN and ATM, which can be considered as a pair as B-ISDN was largely based on ATM, it was the complexity and the cost that prevented them from being materialized. Considerable efforts, such as the Full Service Network (FSN) Initiative organized by several big telecom companies throughout the world in the mid 90's, were made in an attempt to bring the technologies to the marketplace. In the end the cost barrier was still higher than the market would want to accept. In fact, there is another hidden factor for ATM that prevents it from being deployed for integrated services to homes. That hidden factor is the lack of guarantees on the quality of service (QoS). It is well known that ATM builds in considerable mechanisms to enable a best-effort packet network to provide QoS for real-time applications. However, it does not fully guarantee it, in contrast to the Synchronous Optical Network (SONET) system. If billions of dollars were required to invest in building the system, it is unpractical without a solid bottom line for QoS guarantees.

The DSL/ADSL technology was developed for the cupper pair subscriber lines, with the hope that it would carry video and multimedia services. Although it could reach several Mega bits per second (Mbps) in downstream transmissions in some cases, it cannot fulfill the role for carrying integrated services, especially at a time when High Definition TVs (HDTVs) is on the horizon.

Today, on the one side, the world is enjoying the unprecedented success of the Internet and the SONET (the telephone network), as well as the Ethernet as the technology for Local Area Networks (LANs), but on the other side, experiencing a vacuum period without a clear candidate technology for broadband access FTTH or HFC networks.

Given the success of the current three networks, the Internet, the SONET, and the Ethernet, the next generation of FTTH or HFC metro/access network which enables all-in-one services with video on-demand and video communication capacities will likely be the extension of one of these three protocols. Although the Internet protocol (IP) enjoys the flexibility and robustness for datagram services, it is not suited for real-time communications without fundamentally altering the principle of the protocol. Improving the IP for real-time applications would naturally go back the same route of ATM. Our research has indicated that both the SONET and the Ethernet can be the foundation for the FTTH (or HFC) metro networks. Although the SONET has advantages over the Ethernet from a technological point of view, the Ethernet has the advantages in terms of market continuity for equipment manufactures and therefore it is easier to be adopted and further developed. This gives a chance for both protocols, but the Ethernet seems currently to be the industry favorite due to the aforementioned reason. We developed a unique residential gateway for the Ethernet based metro network, which is herein disclosed.

### Residential Gateway

The term of residential gateway or some times referred to as home gateway has been loosely used for many different devices in the literature. For example, the term RG has been used for a device that connects only a group of Ethernet ports to the telephone network through an ADSL modem. In this document we adhere with the definition of an RG as a device that offers a single connection to the metro/access network on one side and multiple ports on the other for connecting residential communication appliances.

The concept of Residential Gateway (RG) whereby multiple resident communication devices are connected to a provider's network or access network is not new. There are a number of journal articles which describe the concept of residential gateways and variety of implementation mechanisms. In the References Cited section, a list of related articles is provided under the subsection title of OTHER PUBLICATIONS.

Numerous mechanisms which are different from the current invention have also been patented, with each for a certain access network infrastructure or with unique RG design architecture and method. In U.S. Pat. No. 6,317,884, a video, data and telephone gateway for an access network of ATM combing with the telephone network was disclosed. The gateway was designed based on a multiple-linear-bus architecture, with the buses on the motherboard to connect the user interfaces and control modules/chips. In U.S. Pat. No. 6,973,074, a residential gateway that transmits digital voice, voiceband data and phone signaling was disclosed. The residential gateway described in U.S. Pat. No. 6,973,074 connects residential telephones and computers to the wide-area-network (WAN) via a home network of a ring configuration that supports levels of transmission priority. Video services were not specified. U.S. Pat. No. 6,272,553 disclosed a multi-services communications device that connects computers, telephones and videos to the communications networks. The disclosed multi-services communications device is similar to a residential gateway but provides only three services (the so-called triple-play), which are computer, telephone, and video. The claimed architecture is a centrally controlled system with the communication processing system being the control module. There were no specific protocol defined for the communications network but four possibilities were claimed, which are modem, Ethernet, DSL and ATM. The details of the communications processing system which is the core for materializing the device was not described to the level of system realization. In U.S. Pat. No. 7,035,270, a home networking gateway was disclosed. The home gateway provides an interface between the home network and the hybrid fiber and coaxial (HFC) access network. A cable modem is used to connect the home devices to the HFC network via a common bus shared by the home devices and a control processor.

The RG disclosed here is a device uniquely designed and implemented using the system-on-chip (SOC) technology, and it is specifically for an Ethernet based metro (or access) network. A Fixed-bandwidth Multimedia to Ethernet (FibME) protocol was invented as the core technology for the design and implementation of the herein disclosed RG.

### System-on-Chip (SOC) and Field Programmable Array (FPGA)

As the name suggests, system-on-chip (SOC) is a technology that implements an entire system or sub-system on one chip. The advantages of SOC include efficiency, reliability, and lower cost. Although SOC can be implemented by the traditional Application-Specific Integrated Circuit (ASIC) methods, the Field Programmable Gate Array (FPGA) technology turned out to be a natural partner of SOC. With the flexibility of designing and implementing hardware by programming the gate arrays and the advantage of testing and re-testing through downloading and re-downloading the firmware and software to the FPGA, the system can be materialized within considerably shorter time than the traditional ASIC methods. Furthermore, products made from FPGAs can be upgraded by simply downloading the upgrades firmware without needing to replace the hardware. The firmware re-downloading can also be achieved through the network. The herein disclosed RG architecture was developed to suit SOC on FPGAs, although AISC methods can be used for implementation. The prototype was implemented using Xilinx Virtex 4 and Virtex II Pro FPGAs.

### SUMMARY OF THE INVENTION

The herein disclosed residential gateway (RG) is a centrally located gateway that connects communication devices to the Ethernet based metro/access network. The communication devices can be either traditional ones, such as TVs, telephones, computers, and cameras, or future new applications, such as networked computer utility billing devices and security/safety sensors. The RG provides industry standard ports for connecting today's home communication appliances, and in the meantime it provides several serial ports, including USB, RS232, UART, and JTAG ports, for future devices. The RG also provides the connection ports for management purposes, which include the keyboard, mouse, and VGA monitor. The connection to the metro network can either be an optic fiber or a coaxial cable depending on the infrastructure of the metro network. The Ethernet is used as the protocol for the communication between the RG and the metro network in both cases. On the residential side, the native format of each device is used for the communication between the corresponding device and the RG, which eliminates the requirements for adaptation interfaces.

In order to use Ethernet frames to transport real-time applications, such as TVs and telephones, a Fixed-bandwidth Multimedia to Ethernet (FibME) protocol was invented to allocate the required bandwidth for each application. The RG guarantees the bandwidth for each application at the gateway level. This means that if the metro network guarantees the bandwidth between the network and the RG, the quality of the service (QoS) is guaranteed by the RG.

### BRIEF DESCRIPTION OF THE DRAWINGS

The accompanying drawings, which are incorporated in the description of the current invention, illustrate the protocols and architecture of the embodiment of the current invention. Together with the description, they serve to explain the principles and mechanisms of the invention.

In the Drawings:

FIG. 1 illustrates the mechanism of the Fixed-bandwidth Multimedia to Ethernet (FibME) protocol;

FIG. 2 provides a block diagram for the residential gateway (RG) architecture;

FIG. 3 depicts the Ethernet frame format with the device logic number in the payload FIG. 4 depicts the extended Ethernet frame with 50 bits global hierarchical address using the original Ethernet address field and some of the preamble bits.

FIG. 5 shows the expanded Ethernet protocol with additional 60 bits global hierarchical address, with the original Ethernet address intact and used for local services within the RG domain.

### DETAILED DESCRIPTION OF THE INVENTION

### Overview

In a preferred embodiment a central gateway device, the said residential gateway (RG), connects multiple communication appliances to an Ethernet based fiber to the home (FTTH) or hybrid fiber and coaxial (HFC) access network. The RG unpacks the Ethernet frames received from the access network which is also referred to as the metro network and distributes the payloads to the destination appliance according to the logical address of the appliance (The logical address of the appliances will be discussed in the section of Addressing Methods later in this document). The RG also packages the upstream data from the applications into Ethernet frames, based on the said FibME protocol, and transmits them to the access network according to the Ethernet protocol. For residential applications, 100 Mbps is used for both the upstream and the downstream directions (full-duplex) as the default. For business applications 1 Gbps or 10 Gbps Ethernet can be used. The RG has been built in the capacity of auto negotiating the bandwidth according to the bandwidth supplied by the metro network. This allows the RG to adapt bandwidth provided by the access network.

The RG guarantees the data delivery in real-time for both upstream and downstream in order to provide the QoS. Thus if the access network provides the subscribed bandwidth, the RG will guarantee the QoS. The RG has also been built in the functionality of buffering the incoming real-time data for playing-back in order to compensate the jitters of the arriving Ethernet frames induced by the network which generically exist in packet networks. The playback time is largely determined by the access network. It is tunable at the RG level by the RG setup controlling functions. The operation of the RG for data transmissions and QoS follows the FibME protocol which is described in the following section.

In the following sections the details of the current invention are presented, which include the FibME protocol, the addressing methods, the architecture of the RG design, as well as the RG implementation.

### The Fixed-Bandwidth Multimedia to Ethernet (FibME) Protocol

Ethernet is a packet network, which transports user data via Ethernet frames. Ethernet was originally invented for Local Area Networks (LANs). However, it is now expanding to larger geographical applications, such as enterprise networks and virtual LANs which may cross hundreds of kilometers. Compared with the Internet Protocol (IP), Ethernet is at the lower layer which requires less processing time at the network switching nodes since the switching is largely performed by hardware instead of software, such as cut-through switches. In many cases, IP is on top of the Ethernet with IP packets being carried by Ethernet frames. With the increasing intelligence of Ethernet switches, the network is able to not only guarantee the switching time but also provide virtual circuits with prioritized services. Furthermore, Ethernet switches can be set for guaranteed bandwidth services should the output bandwidth be equal to or greater than the aggregated input bandwidths. These features are crucial for future broad integrated FTTH metro networks based on the Ethernet.

The fundamental function of the residential gateway is to interconnect an array of residential, or business, communication devices to the metro/access network. The services include both time-critical ones, such as videos and voices, and non-real-time applications, such as Internet connections. In order to efficiently utilize the bandwidth between the RG and the metro network and in the meantime to communicate with the metro/access network using the Ethernet protocol, a Fixed-bandwidth Multimedia to Ethernet (FibME) protocol is devised, which is described as follows:

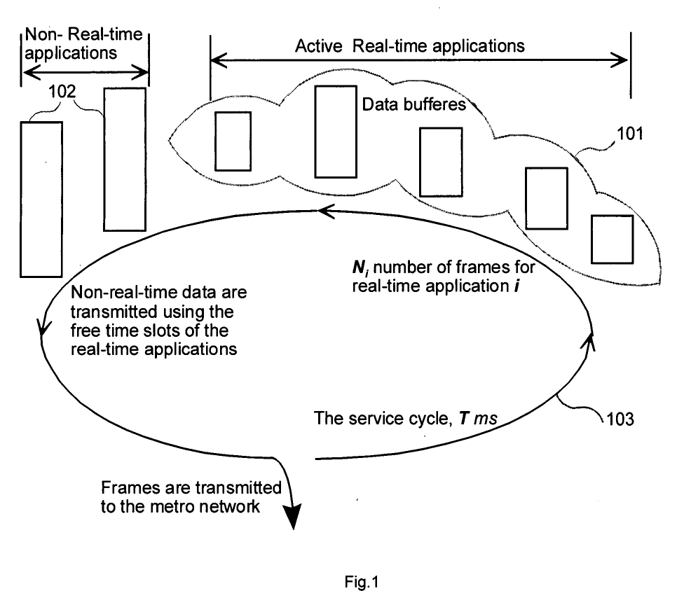

For upstream transmission:
1. Data streams from the active applications, real-time or non-real-time, are packaged individually into Ethernet frames, with each frame containing payload from only one application. This allows each communication to be carried by a stream of Ethernet frames through the metro network without needing to reframe.
2. As shown in FIG. 1, each active application, real-time or non-real-time, will have a buffer to store the data to be transmitted. The buffers for active real-time applications are shown as a group 101. The buffers for non-real-time applications are in a separate group 102.
3. The RG controller, which will be detailed in a future section, serves the applications one round in one fixed time cycle which is called the service cycle 103 in FIG. 1. The duration of the service cycle is denoted by T in milliseconds.
4. In each service cycle, each active real-time application is allocated a fixed number of Ethernet frames to be transmitted contiguously to the network. The number of Ethernet frames allocated to real-time application i is denoted as Nᵢ.
5. The size of the Ethernet frame for each given real-time application is always the same. The sizes of the Ethernet frames among different real-time applications can be different.
6. The frame size, in terms of number of bits in the payload is denoted by bᵢ, and the number of frames to be transmitted in each service cycle for real-time application i are determined by the relation (bᵢ×Nᵢ)/T=Bᵢ, where Bᵢ is the bandwidth requirement, in bps, of application i.
7. The number of active real-time applications is updated when any new application is started.
8. When the aggregated bandwidth of all active real-time applications become greater than the bandwidth provided by the network, which is usually the link bandwidth between the RG and the access network, a warning will be given to the user indicating reduced quality may happen if the user proceeds. In the case that higher compression ratio utilities are implemented within the RG, these utilities may be activated, and consequently, bᵢ and Nᵢ will be recalculated according to the reduced bandwidth Bᵢ. If there is no higher compression utility available, the system can continue to work by reducing Nᵢ. The QoS will not be guaranteed in this case.
9. Non-real-time data are transmitted using the free time slots of real-time applications. That is to say that when the data in the buffer of real-time application i are smaller than the payload of Nᵢ frames with the size of bᵢ, the free time slots leftover by real-time application i are allocated to the non-real-time applications on a first come first served (FCFS) basis.
10. The service cycle repeats itself as long as there is at least one active application, real-time or non-real-time.

### Downstream Transmission:

If the RG controller processes the downstream Ethernet frames in real-time, without extra delay, which is the case of the current disclosed RG design, the downstream frames will be processed in a first come first served (FCFS) fashion, regardless of the real-time or non-real-time data in the payloads of the frames. The RG controller simply distributes the payload of each frame to the destination device port according to the device logic number found in the first 8 (or 16) bits of the payload (The device logic number will be discussed in the following section). The downstream data to a given device will be buffered in a service port buffer corresponding to that device before it is used by the device. The play-back delays are created by the buffering of a block data in the device port buffers, which is also controlled by the RG controller.

### Addressing Methods

In order to communicate through an Ethernet based metro/access network, an Ethernet address is needed for each residential gateway, which is assigned to the Ethernet physical layer interface. Frames designated to one RG have the same Ethernet address, regardless of the service carried. The designation devices of the incoming frames at one RG are identified by the logic number of the devices at the RG level. In the current addressing mechanism, an 8-bit logic number field 205 is allocated in the payload of the Ethernet frame, shown in FIG. 3. The rest of the fields are standard, which are the 64-bit preamble field 201, the 48-bit designation address field 202, the 48-bit source address field 203, the 16-bit payload length field 204, the payload filed 206, the 32-bit CRC field 207, and the 8-bit postamble field 208. Since 8 bits are used to identify the application devices supported the RG, a total of 256 devices can be connected to the RG. This device logic number field can be increased when the RG is used for businesses or organizations, such as 16 bits, which will allow a maximum of 65536 devices.

The RG builds in the functionality of auto-negotiating the data type, such as video, audio, or IP, in order for the receiving side to assign a compatible communication device. This auto-negotiating process takes place during the connection establishment stage. Once the compatible communication devices are matched by the receiving RG, the logic number of the receiving device is sent to the sender, and will be used for the entire session of the communication.

The size of the device logic number field is also acknowledged during the auto-negotiating stage, so that it is known to both the sender and the receiver. This feature provides the flexibility for changing the size of the device logic number field whenever and wherever necessary, without any impact on the system.

For convenience, the RG Ethernet address can also be matched with the user's telephone number, so that the telephone number can be used as the identification for connections. A database similar to the Domain Name Service (DNS) system can be implemented within the metro network to automatically search for the designation Ethernet address when the telephone number is used for communications by the user.

The current RG and its addressing mechanism do not require any changes in the Ethernet protocol. The only difference is that 8, or more, bits of payload are used for user device identifications. However, from the architecture of the metro network view point, a global hierarchical Ethernet is advantageous, which can reduce the switching complexities. Similar to the telephone system, in a Global Hierarchical Ethernet Addressing System (Global-HEAS), in which the Ethernet address will be divided into four fields, which are: the country code, the area code, the local switch code and the user number. Given the world population in the foreseeable future, the number of bits in each of these fields can be allocated as shown in Table 1.

TABLE 1
Bits allocation in the Global Hierarchical Ethernet
Addressing System (Global-HEAS)

| | Field | | | |
|---|---|---|---|---|
| | Country code | Area code | Local switch | User number |
| Field length | 12 bits | 16 bits | 16 bits | 16 bits |

The current IEEE standard Ethernet protocol allocates 48 bits for the Ethernet address, which are sufficient for the area code, and local switch code, and the user number without the country code when mapping to the proposed Global-HEAS. One way to allocate the 12 bits for the country code is to reduce the 64 bits preamble to 40 bits and the remaining 24 bits are used for the country codes of the designation and source addresses. The frame format of the Global-HEAS based on this scheme is shown in FIG. 3, in which the first 40 bits become the preamble 301, the second field 302 contains the designation address of 60 bits, the third field 303 holds the source address of 60 bits, the fourth field 304 is the length filed, the fifth field 305 contains the device logic number of either 8 or 16 bits which are part of the payload from the original Ethernet frame format, the sixth field 306 is the payload, the seventh field 307 contains the CRC bits, and the eighth field 308 is the postamble filed of 8 bits. The bit allocations for the designation address and the sources address are also shown in FIG. 3, with the country code 309 occupying 12 bits, the area code 310, the local switch 311, and the user number 312 having 16 bits respectively. With this proposed Global-HEAS scheme, routing/switching tables can be eliminated. Consequently, the switching node will be significantly simplified in both architecture design and operations, which will lead to lower cost and reliability. Furthermore, with the hierarchical Ethernet addressing, guaranteed bandwidth architecture can be implemented as long as the links provide sufficient bandwidths. This is becoming practical, as optical fibers with DWDM can meet the bandwidth needs with low cost. When using this Global-HEAS, the standard Ethernet transponders need to be adjusted for detecting the preamble field of the Ethernet frames, from 64 bits to 40 bits, which is the only change needed.

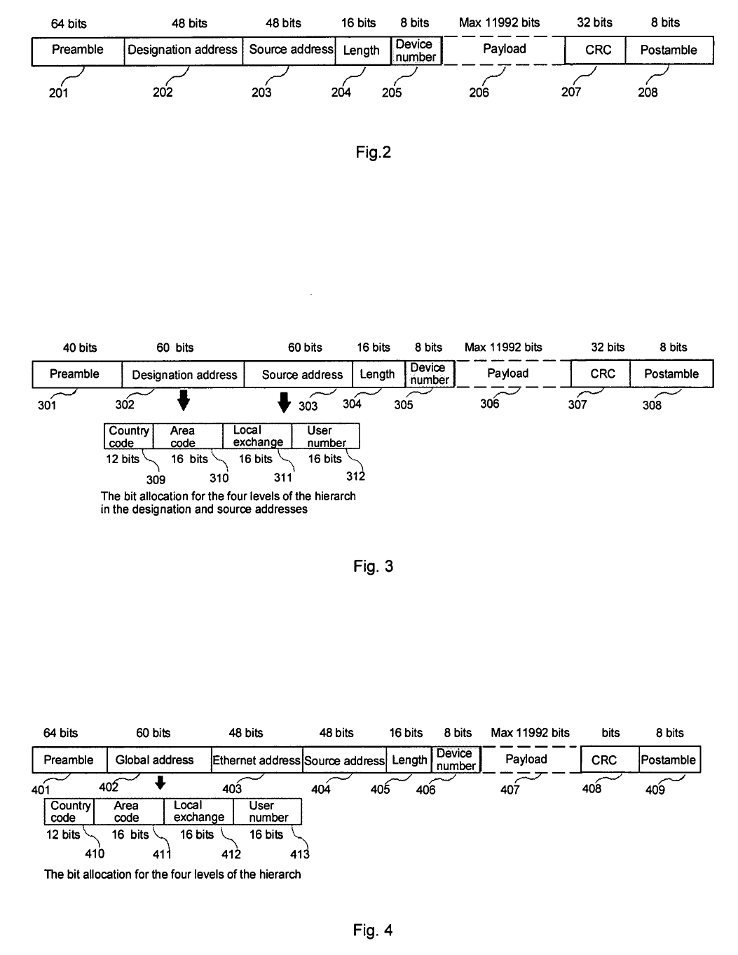

Another mechanism for implementing the hierarchical addressing scheme for packet based metro networks is to add an additional global packet address field and keep the Ethernet address fields as the original Ethernet protocol, which can be used within the RG domain, such as the case of LANs attached to an RG for enterprise users. FIG. 4 shows the frame format of the expanded Ethernet Frames with an additional 60-bit global address 402. The rest fields, the preamble 401, the designation address 403, the source address 404, the length 405, the device number 406, the payload 407, the CRC 408, and the postamble 409, are identical to those that have been described in FIG. 2. The bit allocation for the four levels in the hierarchical global addressing scheme is also depicted in FIG. 4, with the country code 410 occupying 12 bits, the area code 411, the local switch 412, and the user number 413 having 16 bits respectively, which are the same as described in the FIG. 3. Using this addressing scheme, the Ethernet frames are delivered to the designation gateway using the hierarchical global address. The traditional Ethernet address is then used inside the receiver's own domain, which can be a network of LANs. This method not only provides a method for simplified metro network switching, but also allows the continuation of Ethernet uses without needing to change the ways of current Ethernet addresses be assigned. A guaranteed bandwidth metro network architecture based on this global addressing method is disclosed in a separate patent application.

### The Residential Gateway Architecture

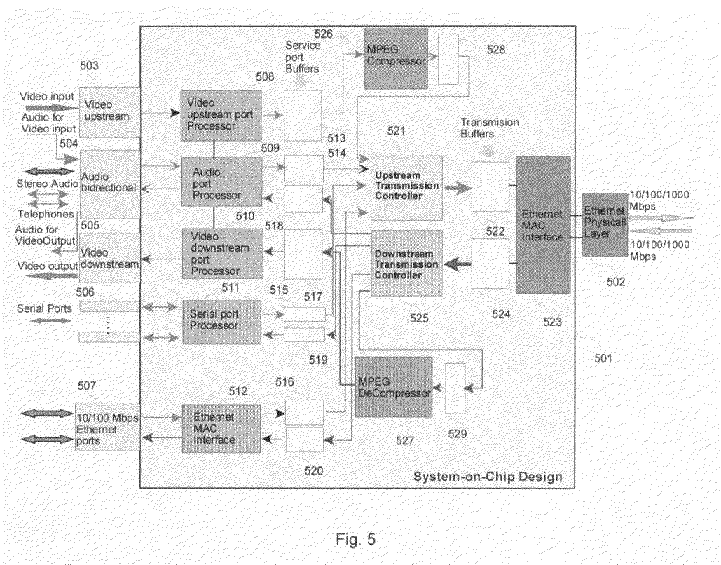

FIG. 5 is the block diagram of the residential gateway (RG). It is a system-on-chip design with the entire RG controlling function being integrated into one chip 501. As shown in FIG. 5, the RG provides one connection to the Ethernet based metro/access network via the Ethernet physical layer 502, through either an optical fiber or a coaxial cable with appropriate interfaces. The RG auto negotiates the transmission speed through the metro network, with the default speed of 100 Mbps for residential applications. The transmission controllers, upstream and downstream, control the bidirectional Ethernet frame transmissions according to the FibME protocol described in the previous section.

On the user side of the RG, a group of interfaces are used to connect user appliances to the RG for both upstream and downstream services, which include videos upstream 503, bidirectional audio with telephones 504, video downstream 505, a bank of serial ports 506 for future applications, and computers (through Ethernet ports) 507, as shown in FIG. 5. For each user side I/O port, a port processor is designed to process the user data, including format conversions and timing. The port processors are: video upstream processor 508, audio bidirectional processor 509, video downstream processor 510, serial ports processor 511, and user-side Ethernet processor 512. For upstream transmissions, the port processor will take the user data stream, process it, and store it in the service port buffers for further processing. For downstream transmissions, the port processors will take the downstream data from the port buffers and convert them to the native format of the device connected the port. The port processors run different clock speed with each matching the requirement of the corresponding port.

The upstream data received from each user device port are stored in the corresponding service port buffer after the processed by the port control processor. The upstream service port buffers are: video 513, audio 514, serial ports 515, and user-side Ethernet 516. The downstream data are also stored in their corresponding service port buffers before transported to their corresponding service port by the corresponding port control processor. The downstream service port buffers are: for video 517, for audio 518, for serial ports 519, and for the user-side Ethernet 520.

As shown in FIG. 5, a pair of transmission controllers is designed for controlling the upstream and downstream data transmissions. The upstream transmission controller 521 is responsible for framing and bandwidth allocation according to the aforementioned FibME protocol. The Ethernet frames coming out of the upstream transmission controller will be stored in the upstream transmission buffer 522 with the order produced by the controller. The Ethernet MAC interface 523 will then pump out the frames in the transmission controller 521 in a first-come-first-served (FCFS) basis. For the downstream data received by the Ethernet MAC interface will be stored in the downstream transmission buffer 524. The downstream transmission controller 525 will take the data from the transmission buffer 524 also in the FCFS order.

Also, shown in FIG. 5, an MPEG compressor 526 and a MPEG decomprssor 527 are also included in the RG chip 501. The MPEG compressor compresses the upstream video data before handing them to the upstream transmission control 521 through a dedicated buffer 528. The MPEG decompressor decompresses the downstream video data from the network via the downstream transmission controller 525 through a dedicated buffer 529 and hands them to the video port processor 510 through service port buffer 517. The compression and decompression of audio data are integrated within the audio port controller 509.

The entire design shown in FIG. 5 is integrated into one chip 501. This provides not only the processing speed required, but also the reliability of the product. Furthermore it also reduces the cost, as the manufacturing technologies are readily available.

### The RG Implement

The prototype of the RG is implemented by using Xilinx FPGAs. The entire RG controller, shown in FIG. 5, is implemented with one Xilinx Virtex 4 FPGA. A second FPGA, the Xilinx Virtex II Pro, is used to control the device interfaces. An operating system is also run on the Virtex II Pro FPGA for system maintenance purposes.

The blocks in FIG. 5 are implemented by programming the FPGA chip with each block being implemented as one module. The modules are tested individually before being assembled together as the whole RG device.

The port processors are finite state machines which run by hardware only. The upstream and downstream transmission controllers each consists of a finite state machine and a processor. The software, programmed in C language and run by the processor, works together with the finite state machine to achieve the controlling function of upstream and downstream transmission according to the FibME protocol. With this design and implementation, the RG can be upgraded in the future by reloading the firmware which is the code of configuring the FPGA and the software without the need to replace hardware.

### REFERENCES CITED

### U.S. Patents

U.S. Pat. No. 6,317,884 Video, data and telephone gateway
U.S. Pat. No. 6,272,553 Multi-services communications device
U.S. Pat. No. 7,035,270 Home networking gateway
U.S. Pat. No. 6,973,074 December 2005, Maranhao, Transmission of digitized voice, voiceband data, and phone signal over priority-based local area network without the use of voice IP techniques or a separate voice-dedicated network

### Other Publications

Jieunn, Kim; Sangjae, Lee; Youngae, Jeon; Sangsung, Choi, “Residential HDTV distribution system using UWB and IEEE 1394,” Consumer Electronics, IEEE Transactions on Volume: 52, Issue: 1, February 2006, pp. 116-122.
Jae-Won, Kim; Goo-Rak, Kwon; Nam-Hyeong, Kim; Morales, A.; Sung-Jae, Ko, “Efficient video transcoding technique for QoS-based home gateway service,” Consumer Electronics, IEEE Transactions on Volume: 52, Issue: 1, February 2006, pp. 129-137.
Wan-Ki, Park; Sung-Il, Nam; Chang-Sic, Choi; Youn-Kwae, Jeong; Kwang-Roh, Park, “An implementation of FTTH based home gateway supporting various services,” Consumer Electronics, IEEE Transactions on Volume: 52, Issue: 1, February 2006, pp. 110-115.
Vilas, Ana Fernández; Díaz Redondo, Rebeca P.; Cabrer, Manuel Ramos; Pazos Arias, José J.; et. al., “MHP-OSGi convergence: a new model for open residential gateways,” Software: Practice and Experience Volume: 36, Issue: 13, 10 Nov. 2006, pp. 1421-1442.
Ana Frenández et al, “MHP-OSGi convergence: a new model for open residential gateways,” Wiley InterScience (www.interscience.wiley.com) DOI:10.1002/spe.272, 2006; 36: pp. 1421-1442.
Wan-Ki, Park; Dae-Young, Kim, “Convergence of broadcasting and communication in home network using an EPON-based home gateway and overlay,” Consumer Electronics, IEEE Transactions on Volume: 51, Issue: 2, May 2005, pp. 485-493.
Wen-Shyang, Hwang; Pei-Chen, Tseng, “A QoS-aware residential gateway with bandwidth management,” Consumer Electronics, IEEE Transactions on Volume: 51, Issue: 3, August 2005, pp. 840-848.
Yun-Sheng, Yen; Lin, F.; Han-Chieh, Chao, “Residential Gateways,” Consumer Electronics, IEEE Transactions on Volume: 51, Issue: 3, August 2005, pp. 824-830.
Shuguang, Gong; Huawei, Li; Xiaowei, Li, “An innovative free memory design for network processors in home network gateway,” Consumer Electronics, IEEE Transactions on Volume: 51, Issue: 4, November 2005, pp. 1182-1187.
F. T. H den Hartog; Balm, M.; de Jong, C. M.; Kwaaitaai, J. J. B., “Convergence of residential gateway technology,” Communications Magazine, IEEE Volume: 42, Issue: 5, May 2004, pp. 138-143.
Xie, Li; Wenjun, Zhang, “The design and implementation of home network system using OSGi compliant middleware,” Consumer Electronics, IEEE Transactions on Volume: 50, Issue: 2, May 2004, pp. 528-534.
Bansal, D.; Bao, J. Q.; Lee, W. C., “QoS-enabled residential gateway architecture,” Communications Magazine, IEEE Volume: 41, Issue: 4, April 2003, pp. 83-89.
Kwangroh, Park; Yeunjoo, Oh; Kyungshik, Lim; Kyoungrok, Cho, “A real-time voice service with the adaptive packet loss recovery scheme in the hybrid residential gateway system,” Consumer Electronics, IEEE Transactions on Volume: 49, Issue: 2, May 2003, pp. 359-366.
Orphanoudakis, Theofanis; Perissakis, Stylianos; Pramataris, Kostas; Nikolaou, Nikos; Zervos, Nick; et. al., “Hardware Architectures for the Efficient Implementation of Multi-Service Broadband Access and Multimedia Home Networks,” Telecommunication Systems Volume: 23, Issue: 3-4, July 2003, pp. 351-367.
Kushiro, N.; Suzuki, S.; Nakata, M.; Takahara, H.; Inoue, M., “Integrated residential gateway controller for home energy management system,” Consumer Electronics, IEEE Transactions on Volume: 49, Issue: 3, August 2003, pp. 629-636
Changseok, Bae; Jinho, Yoo; Kyuchang, Kang; Yoonsik, Choe; Jeunwoo, Lee, “Home server for home digital service environments,” Consumer Electronics, IEEE Transactions on Volume: 49, Issue: 4, November 2003, pp. 1129-1135.
Bull, P M; Benyon, P R; Limb, P R, “Residential Gateways,” BT Technology Journal Volume: 20, Issue: 2, April 2002, pp. 73-81.
Valtchev, D.; Frankov, I., “Service gateway architecture for a smart home,” Communications Magazine, IEEE Volume: 40, Issue: 4, April 2002, pp. 126-132.
Wils, A.; Matthijs, F.; Berbers, Y.; Holvoet, T.; De Vlaminck, K., Device discovery via residential gateways,” Consumer Electronics, IEEE Transactions on Volume: 48, Issue: 3, August 2002, pp. 478-483.
Zahariadis, T.; Pramataris, K.; Zervos, N., “A comparison of competing broadband in-home technologies,” Electronics & Communication Engineering Journal Volume: 14, Issue: 4, August 2002, pp. 133-142.
Zahariadis, Th.; Pramataris, K., “Multimedia home networks: standards and interfaces,” Computer Standards and Interfaces Volume: 24, Issue: 5, November, 2002, pp. 425-435.
Gong, L., “A software architecture for open service gateways,” IEEE Internet Computing Volume: 5, Issue: 1, 2001, pp. 64-70.
Shaowen Song, “A real-time residential gateway operating system,” Computer Communications Volume: 23, Issue: 9, Apr. 15, 2000, pp. 825-834.
Song, Shaowen, “A credit-based flow control algorithm for broadband access networks,” Computer Networks Volume: 34, Issue: 2, August, 2000, pp. 279-295.
Saito, T.; Tomoda, I.; Takabatake, Y.; Arni, J.; Teramoto, K., “Home gateway architecture and its implementation,” Consumer Electronics, IEEE Transactions on Volume: 46, Issue: 4, November 2000, pp. 1161-1166.
Saito, T.; Tomoda, I.; Takabatake, Y.; Ami, J.; Teramoto, K., “Home gateway architecture and its implementation,” Consumer Electronics, IEEE Transactions on Volume: 46, Issue: 4, November 2000, pp. 1161-1166.
Waring, David L.; Kerpez, Kenneth J.; Ungar, Steven G., “A newly emerging customer premises paradigm for delivery of network-based services,” Computer Networks Volume: 31, Issue: 4, Feb. 25, 1999, pp. 411-424.
Jae-Chul, Moon; Hyo-Sang, Lim; Soon-Ju, Kang, “Real-time event kernel architecture for home-network gateway set-top-box (HNGS),” Consumer Electronics, IEEE Transactions on Volume: 45, Issue: 3, August 1999, pp. 488-495.
Corcoran, P. M., “Mapping home-network appliances to TCP/IP sockets using a three-tiered home gateway architecture,” Consumer Electronics, IEEE Transactions on Volume: 44, Issue: 3, August 1998, pp. 729-736.
Cucos, A.; Corcoran, P. M., “Real time ATM for remote access to home automation and digital home A/V networks,” Consumer Electronics, IEEE Transactions on Volume: 44, Issue: 3, August 1998, pp. 482-489.
Holliday, C. R., “The residential gateway,” Spectrum, IEEE Volume: 34, Issue: 5, May 1997, pp. 29-31.
Honda, Y.; Kushiro, N.; Maruyama, K.; Ashizawa, T., “An optimized gateway controller for HA system and automatic meter reading system,” Consumer Electronics, IEEE Transactions on Volume: 37, Issue: 3, August 1991, pp. 388-394.
D. B. Keck, Fellow, IEEE, A. J. Morrow, D. A. Nolan and D. A. Thompson, “Passive Components in the Subscriber Loop,” (Invited Paper) in Journal of Lightwave Technology, Vol. 7, No. 11. November 1989.
Todd, T., “A Traffic Scheduling Technique for Metropolitan Area Gateways,” Selected Areas in Communications, IEEE Journal on Volume: 5, Issue: 9, December 1987, pp. 1391-1402.
Lawrence, V.; Zervos, N.; Zahariadis, T.; Meliones, A., “Digital Gateways for Multimedia Home Networks,” Selected Areas in Communications, IEEE Journal on Volume: 4, Issue: 8, November 1986, pp. 1230-1240.

What is claimed is:

1. A residential gateway (RG) method and system that connects multimedia residential communication appliances to an Ethernet based metro/access network, the RG comprising:
a receiving Ethernet frames from the metro/access network, and distributing the payloads of the Ethernet frames to their designation residential or alike devices, according to the said Fixed-bandwidth Multimedia to Ethernet (FibME) protocol.
b. transmitting the upstream data from active devices in real-time to the metro/access network by encoding the data into Ethernet frames with each frame containing data from only one specific device (service). The bandwidth sharing among the active applications is governed by the FibME protocol which guarantees the quality of service (QoS) under the condition that the metro/access network provides the required bandwidth.
c. providing MPEG compression for upstream video and audio data in real-time, and providing MPEG decompression for downstream video and audio data also in real-time.
d. providing playback times for video and audio, with the length of the playback for each application being tunable.

2. The RG method and system as defined in claim 1 wherein the in-home devices are connected to the RG through standard ports that are native to the devices.

3. The RG method and system as defined in claim 1 wherein future devices are connected to the RG through standard serial ports that include USB, RS232, UART, and JTAG.

4. The RG method and system as defined in claim 1 wherein the connection between the RG and the metro/access network is achieved by an Ethernet interface through either optic fiber or a coaxial cable wherein interfaces may required for a given case.

5. The RG method and system as defined in claim 1 wherein the upstream data from user devices are packaged into Ethernet frames with a device logic number being inserted in the first 8 (or 16) bits of the payload.

6. The RG method and system as defined in claim 1 wherein the downstream data from the metro/access network are distributed to the designation devices according to the device logic number found in the first 8 (or 16) bits of the payload.

7. The RG method and system as defined in claim 1 wherein the bandwidth sharing is achieved by multiplexing Ethernet frames in accordance with the FibME protocol which guarantees the QoS when sufficient bandwidth is provided by the metro/access network.

8. The RG method and system as defined in claim 1 wherein the residential gateway further comprises a group of service port processors with each processor being responsible for its corresponding port.

9. The RG method and system as defined in claim 1 wherein the residential gateway further comprises a pair of transmission controllers with one being the upstream transmission controller which is responsible for upstream data transmission according to the FibME protocol and the other being the downstream transmission controller which is responsible for distributing the downstream data to the multimedia service ports.

10. The RG method and system as defined in claim 1 wherein the residential gateway further comprises a group of service port buffers to store the data from or to the ports for further processing.

11. The RG method and system as defined in claim 1 wherein the residential gateway further comprises a pair of transmission buffers with the upstream transmission buffer holding the ready-to-transmit Ethernet frames organized by the upstream transmission controller and the downstream transmission buffer holding the Ethernet frames received from the network.

12. The RG method and system as defined in claim 1 wherein the residential gateway further comprises a video data compressor for upstream video data compression in accordance with the MPEG standard.

13. The RG method and system as defined in claim 1 wherein the residential gateway further comprises a video data decompressor for downstream video data decompression in accordance with the MPEG standard.

14. A Global Hierarchical Ethernet Addressing System (Global-HEAS) comprising a hierarchical network address (HNA) for simplifying network switching, wherein the HNA further comprising a country code, an area code, a local switch code and a user number.

15. The Global-HEAS defined in claim 14 wherein the HNA can be implemented by:
a. either modifying the Ethernet standard wherein the standard Ethernet designation and source addresses are expanded to 60 bits in order to be able to encode the country code, the area code, the local switch code and the user number; or
b. adding the HNA field on top of the standard Ethernet address so that the HEAS frames are delivered by the Global-HEAS and the existing Ethernet addresses are used in the user domain.
